(19) United States
(12) Patent Application Publication
(10) Pub. No.: US 2009/0298421 A1
(43) Pub. Date: Dec. 3, 2009

(54) MULTIBEAM REFECT ARRAY

(75) Inventors: Mats H. Andersson, Goteborg (SE); Paul Hallbjörner, Goteborg (SE); Anders Rydberg, Uppsala (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/994,578

(22) PCT Filed: Jul. 4, 2005
(86) PCT No.: PCT/SE2005/001083

§ 371 Date: Jan. 3, 2008

(51) Int. Cl. H04B 7/15

(52) U.S. Cl. 455/11.1

(57) ABSTRACT

The invention discloses a repeater antenna for use in point-to-point applications in telecommunications systems in the microwave range, intended for connecting transmissions from a first radio unit at a first site to a second radio unit at a second site. The repeater antenna is essentially plane, and is designed as a traveling wave antenna with at least a first and a second antenna beam, so that the first beam can be used for transmissions to and from said first radio unit, and the second beam can be used for transmissions to and from said second radio unit.

### TECHNICAL FIELD

The invention discloses a repeater antenna for use in point-to-point applications in telecommunications systems in the microwave range, the repeater antenna being intended for connecting transmissions from a first radio unit at a first site to a second radio unit at a second site.

### BACKGROUND ART

In telecommunications systems such as, for example, cellular telephony systems in the microwave range, there can be a number of problems for a base station when trying to communicate with the users located in the area covered by the base station. In urban areas, examples of such problems can be high rise building which obstruct the line of sight to certain sub-areas, or that in certain sub-areas the concentration of users can exceed that which can be handled by the base station.

One way of handling these problems is to install other base stations which can cover the sub-areas in question, usually base stations with smaller capacity, so called “pico-stations”. These “pico-stations” then need to be connected to the network in some way, suitably with the pico-station as one of the points in a point-to-point connection. Since the sub-area in question usually would not have Line of Sigh (LOS) to the base station, said point-to-point connection could be made by means of a repeater station, which would be directed at the “pico-station” from the base station, or from a higher level in the network.

Conventional repeater antennas are usually designed by means of two reflector antennas, often parabolic dishes, connected by means of a waveguide and pointed in different directions. Installing such repeaters, especially in urban areas, is becoming increasingly difficult, due to a number of factors such as aesthetic considerations and difficulties in finding sufficient space for a repeater site.

Another kind of previously known repeater is merely a large sheet of reflective material, such as metal. Such a repeater would suffer from a number of drawbacks, for example high losses due to low directivity, and would generally not be suitable for use in urban areas.

### DISCLOSURE OF THE INVENTION

As described above, there is thus a need for a repeater antenna in a point-to-point telecommunications system which would overcome the previously described drawbacks of known repeater antennas.

This need is addressed by the invention in that it discloses a repeater antenna for use in point-to-point applications in telecommunications systems in the microwave range, intended for connecting transmissions from a first radio unit at a first site to a second radio unit at a second site.

The repeater antenna it is essentially plane, and is designed as a travelling wave antenna with at least a first and a second antenna beam, which means that the first beam can be used for transmissions to and from a first radio unit, for example a base station, and the second beam can be used for transmissions to and from a second radio unit, suitably a “pico station”.

In one embodiment, the repeater antenna comprises antenna elements which are created on a sheet of electrically conducting material, the repeater antenna additionally comprising a ground plane spaced apart from the antenna elements by means of a dielectric material.

### BRIEF DESCRIPTION OF THE DRAWINGS

The invention will be described in more detail in the following description, with reference to the appended drawings, in which

FIG. 1 shows a schematic overview of the system in which the invention may be applied, and

FIGS. 2-6 show different embodiments of the repeater antenna of the invention.

### EMBODIMENTS OF THE INVENTION

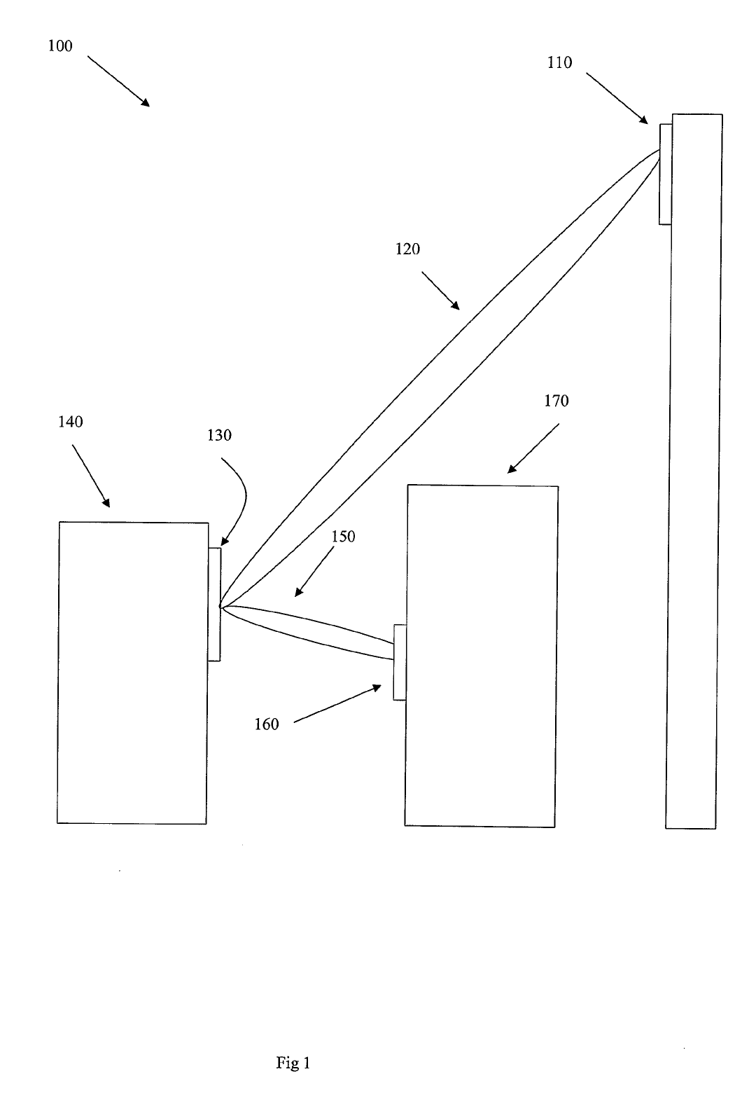

FIG. 1 shows a system 100 in which a repeater antenna of the invention may be used. The system 100 shown is a cellular telephony system, which should be seen merely as an example of an embodiment intended to facilitate the explanation of the invention, the repeater antenna can be used in a wide variety of other applications, as will be realized by those skilled in the field.

A first radio unit 110, in this case a radio base station in the cellular system 100, is unable to provide adequate service to an area in its cell, since a building 170 obscures the area from radio coverage by the base station 110.

In order to service the obscured area, a second radio unit or base station 160 has been deployed on the building 170, so that the antenna of the station 160 can cover the obscured area. The second radio unit 160 may be a base station similar to the base station 110, but it can also be a base station with a reduced capacity compared to the base station 110, a so called “pico station”.

In order to connect the first radio unit 110 to the second radio unit 160, a repeater antenna 130 of the invention has been deployed on a building 140 in a position where it may connect the base station 110 to the pico station 160.

In order to give the operator of the system 100 the possibility of deploying the repeater antenna 130 in a wide variety of places without causing too much aesthetic damage, the repeater antenna 130 is essentially plane, and may thus easily blend into the background, especially if covered by a suitable radome.

The repeater antenna 130 has a first 120 and a second 150 antenna beam, by means of which both the base stations 110,160 may be covered.

As indicated in FIG. 1, the first beam 120 is used to connect the repeater antenna 130 to the base station 110, in other words the first beam is used for transmissions between the repeater 130 and the base station 110, and the second beam 150 of the repeater 130 is used to connect the repeater antenna 130 to the base station 160, in other words the second beam is used for transmissions between the repeater 130 and the “pico” station 160.

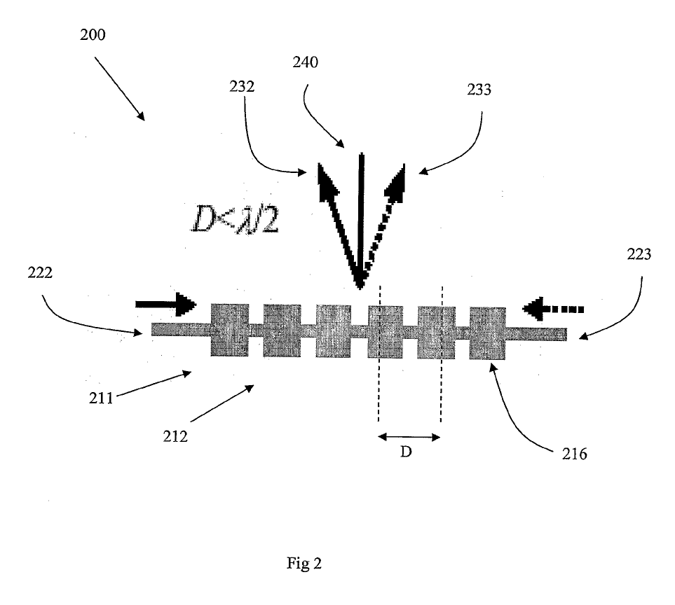

The design of the repeater antenna 130 as well as some variations of said design will now be described with reference to FIGS. 2-6.

FIG. 2 shows an example of the antenna 200 which is used in the invention. The antenna 200 is an array antenna of the so called “travelling wave” type, with at least a first 211 and a second 212 radiation element, which are arranged serially at a centre distance D from each other. Since the radiation elements are connected serially to each other, there will be a first 211 and a second “end element” to which are attached input/output ports 222, 223, of the antenna 200.

As shown in FIG. 2, the antenna 200 has a first and a second antenna beam 232, 233, each of which is associated with one of the antenna ports 222, 223. This means that the first beam 232 may be used by accessing the first port 222, and in a similar way the second beam 233 is associated with the second port 223. The angle between the beams is determined by the centre distance D between the antenna elements of the antenna.

As can also be seen in FIG. 2, the two antenna beams of the travelling wave antenna are each other's “mirror image” with respect to an imagined line which extends in a direction perpendicular to the antenna. Thus, the two beams are sometimes referred to as the “plus” or the “minus”-directions.

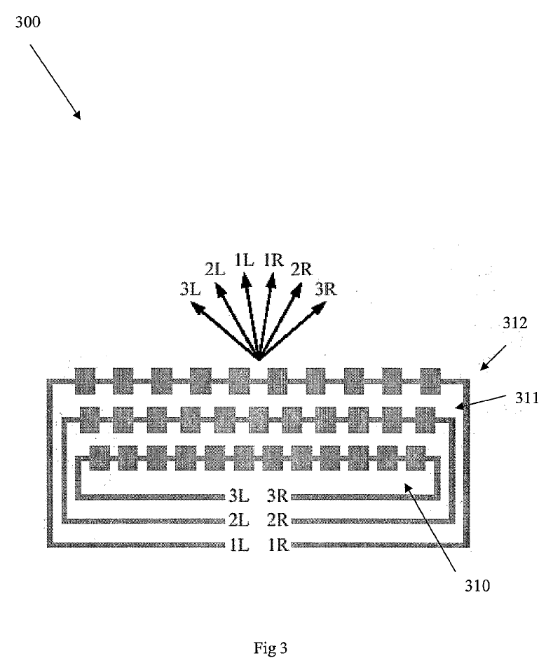

FIG. 3 shows another version 300 of the antenna of the invention. In this version, the antenna 300 is comprised of a plurality of travelling wave antennas of the kind shown and described in connection to FIG. 2. In FIG. 3, three antennas 310, 311, 312, are shown, although the number of antennas may naturally be varied rather freely.

In accordance with the principle described earlier, the use of three travelling wave antennas will result in six different antenna beams 3L-3R, each beam being associated with one of six different antenna ports 331-337.

If the antenna 300 is to be used in so called MIMO applications, this may be carried out in the following manner: A MIMO (Multiple Input Multiple Output) system transmits N data streams on an antenna having M beams, with M≧2N, with a suitable degree of decorrelation between the different antenna beams. One MIMO beam may be received in each one of the M antenna beams, and retransmitted in another of the antenna beams, with the decorrelation between the MIMO data streams being retained upon retransmission, due to the antenna being designed and used so that there is sufficient decorrelation between the antenna beams which are used for reception and retransmission respectively.

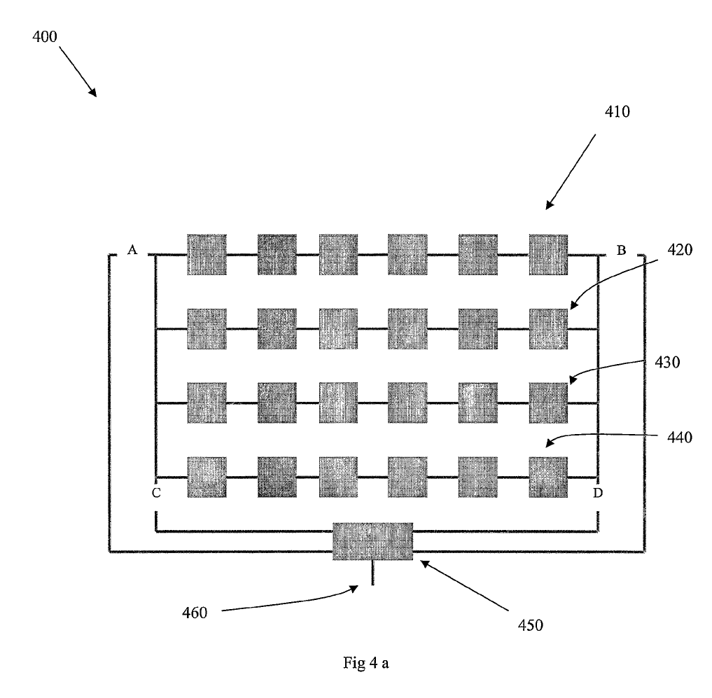

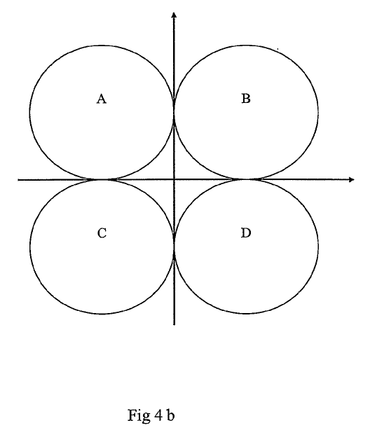

In FIG. 4a, an alterative version of the antenna 400 according to the invention is shown. The main difference between the antenna 400 and the antenna 300 shown in FIG. 3 is that the antenna 300 comprises three one-dimensional travelling wave antennas, by means of which six beams (two from each antenna) can be created, all of which are in the same elevational plane.

As opposed to the antenna 300, the antenna 400 in FIG. 4 comprises a plurality 410-440 of one-dimensional travelling wave arrays which are also interconnected at their respective ends, thus creating a two dimensional array antenna. The two-dimensional array antenna is a well known concept to those skilled in the art, so it will not be described in detail here. However, as shown in FIG. 4, the antenna 400 comprises a switching unit 450 and a connection point 460. A data stream which is connected to the antenna at 460 may by means of the switching unit be connected to any of the points A, B, C, or D indicated in FIG. 4.

In FIG. 4b, the four different antenna beams which will be created when connecting to each of the respective points A, B, C, D, are shown. These beams are shown in the same plane as the antenna in FIG. 4a, i.e. in a plane which is “face-on” with respect to the paper.

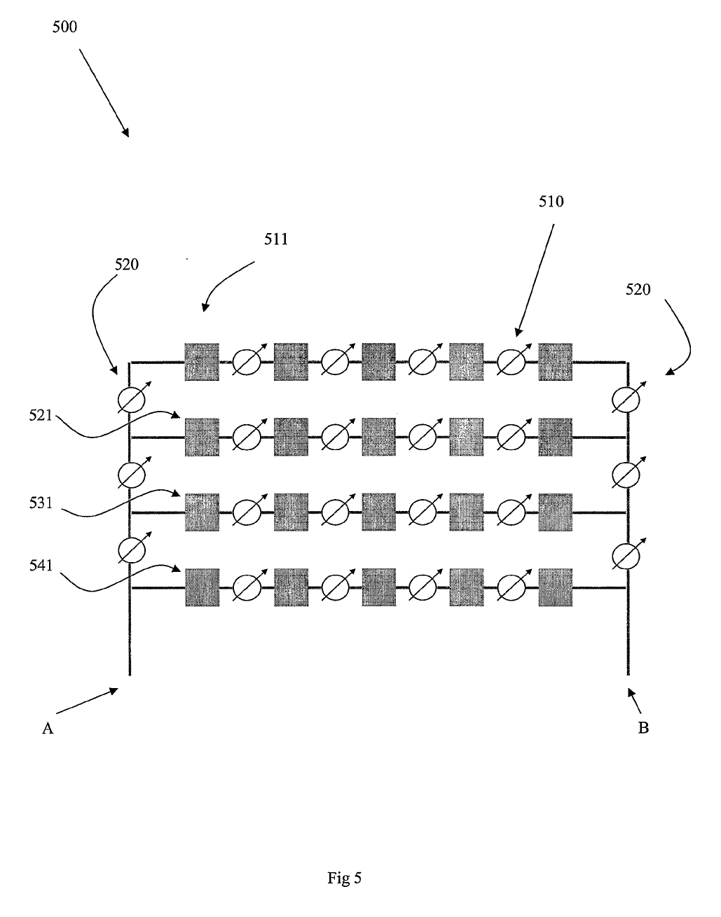

In FIG. 5, an alternative antenna 500 for use in the invention is shown. The antenna 500 is similar to that shown in FIG. 4 in that it comprises a plurality 511, 521, 531, 541, of one-dimensional travelling wave arrays which are also interconnected at their respective ends, thus creating a two dimensional array antenna, but in the antenna 500, variable phase shifters 510 are arranged between the radiation elements in the individual arrays, as well as variable phase shifters 520 being arranged on the connections which connect the one-dimensional arrays to each other.

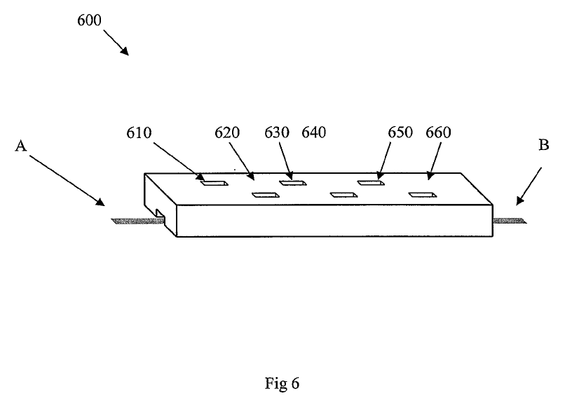

The antenna is fed at two points A and B, both of which are indicated in FIG. 6, and gives rise to two beams, both of which can be steered by means of the phase shifters adaptively, in a manner which as such is well known, with the phase shifters 510 being used to steer the antenna beams in a first direction, and the phase shifters 520 being used to steer the antenna beams in a second direction which is essentially perpendicular to the first direction.

Connections to the antenna are made via the connection points A and B.

The antenna 500 can also be fed in the four points used with the antenna 400 in FIG. 4, in which case four beams will be generated.

Naturally, the antenna 500 may be varied, for example in that it doesn't need to comprise all of the phase shifters 510, 520, which are shown in FIG. 5.

The invention is not limited to the examples of embodiments shown above, but may be freely varied within the scope of the appended patent claims. For example, an antenna which is a travelling wave antenna may be designed in other ways than those shown above, and doesn't necessarily need to comprise resonant elements. A so called leaky cable is one example of a travelling wave antenna without resonant elements.

FIG. 6 shows another example of an embodiment 600 of a travelling wave antenna: a waveguide has a number of apertures 610-660 which will act as radiation elements. In similarity to the antenna 200 shown in FIG. 2, the antenna 600 is fed at the two end points A and B respectively of the antenna, and creates two beams, in similarity to the antenna 200.

1.-5. (canceled)

6. A repeater antenna for use in point-to-point applications in telecommunications systems in the microwave range, the repeater antenna adapted to connect transmissions from a first radio unit at a first site to a second radio unit at a second site, said repeater antenna comprising:
an essentially plane shape and designed as a traveling wave antenna with at least a first and a second antenna beam, so that the first beam can be used for transmissions to and from said first radio unit, and the second beam can be used for transmissions to and from said second radio unit.

7. The repeater antenna of claim 6, which, in addition to having an essentially plane shape, is also essentially flat.

8. The repeater antenna of claim 6, which is a passive repeater antenna.

9. The repeater antenna of claim 6, which is an active repeater antenna.

10. The repeater antenna of claim 6, comprising antenna elements which are created on a sheet of electrically conducting material, the antenna additionally comprising a ground plane spaced apart from the antenna elements by means of a dielectric material.

11. The repeater antenna of claim 10, which, in addition to having an essentially plane shape, is also essentially flat.

12. The repeater antenna of claim 10, which is a passive repeater antenna.

13. The repeater antenna of claim 10, which is an active repeater antenna.
